(19) United States
(12) Patent Application Publication
(10) Pub. No.: US 2012/0100441 A1
(43) Pub. Date: Apr. 26, 2012

(54) OXYGEN-CONSUMING ELECTRODE

(75) Inventors: Andreas Bulan, Langenfeld (DE); Jürgen Kintrup, Leverkusen (DE); Heinrich Morhenn, Koln (DE)

(73) Assignee: Bayer MaterialScience AG, Leverkusen (DE)

(21) Appl. No.: 13/271,671

(22) Filed: Oct. 12, 2011

(30) Foreign Application Priority Data
Oct. 21, 2010 (DE) 102010042730.6

(51) Int. Cl. H01M 4/86; H01M 8/22; C25B 11/08; C25B 1/34; C25B 11/04; C25B 11/03

(52) U.S. Cl. 429/405; 204/290.01; 204/284; 204/290.11; 204/290.14; 205/532; 429/523

(57) ABSTRACT

The present invention relates to an oxygen-consuming electrode comprising a support in the form of a sheet-like structure and a coating comprising a gas diffusion layer and a catalytically active component, wherein the support is based on a material which can be at least partly removed by dissolution, decomposition, melting and/or vaporization. Furthermore, the use of this oxygen-consuming electrode in chloralkali electrolysis or fuel cell technology is described.

### CROSS REFERENCE TO RELATED APPLICATIONS

Priority is claimed to German patent Application no. 10 2010 042 730.6, filed Oct. 21, 2010, which is incorporated herein by reference in its entirety for all its useful purposes.

### BACKGROUND

The field of the invention relates to an oxygen-consuming electrode having a support in the form of a sheet-like structure, characterized in that the sheet-like structure is based on a dissolvable material. The field of the invention further relates to a process for producing oxygen-consuming electrodes and to the use of this oxygen-consuming electrode in chloralkali electrolysis or fuel cell technology.

The invention proceeds from oxygen-consuming electrodes known per se which are configured as gas diffusion electrodes and usually comprise an electrically conductive support and a gas diffusion layer having a catalytically active component.

Various proposals for operating the oxygen-consuming electrodes in electrolysis cells of an industrial size are known in principle from the prior art. The basic idea is to replace the hydrogen-evolving cathode in the electrolysis (for example in chloralkali electrolysis) by the oxygen-consuming electrode (cathode). An overview of possible cell designs and solutions may be found in the publication by Moussallem et al. “Chlor-Alkali Electrolysis with Oxygen Depolarized Cathodes: History, Present Status and Future Prospects”, J. Appl. Electrochem. 38 (2008) 1177-1194.

The oxygen-consuming electrode, hereinafter also referred to as OCE for short, has to meet a number of requirements in order to be able to be used in industrial electrolysers. Thus, the catalyst and all other materials used have to be stable to sodium hydroxide solution having a concentration of about 32% by weight and to pure oxygen at a temperature of typically 80-90° C. A high measure of mechanical stability is likewise required since the electrodes are installed and operated in electrolysers having a size of usually more than 2 m² in area (industrial size). Further properties are: a high electrical conductivity, a low layer thickness, a high internal surface area and a high electrochemical activity of the electrocatalyst. Suitable hydrophobic and hydrophilic pores and an appropriate pore structure for the conduction of gas and electrolyte are likewise necessary, as is impermeability so that gas space and liquid space remain separated from one another. Long-term stability and low production costs are further particular requirements which an industrially usable oxygen-consuming electrode has to meet.

A further development direction for the use of OCE technology in chloralkali electrolysis is the ion-exchange membrane which separates the anode space from the cathode space in the electrolysis cell without the sodium hydroxide gap being directly adjacent to the OCE. This arrangement is also referred to as the zero gap arrangement in the prior art. This arrangement is usually also employed in fuel cell technology. A disadvantage here is that the sodium hydroxide formed has to be conveyed through the OCE to the gas side and subsequently flows downward at the OCE. Blockage of the pores in the OCE by the sodium hydroxide solution or crystallization of sodium hydroxide in the pores must not occur here. It has been found that very high sodium hydroxide concentrations can also occur, and the ion-exchange membrane is not stable to these high concentrations in the long term (Lipp et al., J. Appl. Electrochem. 35 (2005)1015—Los Alamos National Laboratory “Peroxide formation during chloralkali electrolysis with carbon-based ODC”).

A conventional oxygen-consuming electrode typically comprises an electrically conductive support element to which the gas diffusion layer having a catalytically active component is applied. As hydrophobic component, use is made of, for example, polytetrafluoroethylene (PTFE) which also serves as polymeric binder for the catalyst. In the case of electrodes having a noble metal catalyst, the noble metal serves as hydrophilic component.

A metal, a metal compound, a non-metallic compound or a mixture of metal compounds or non-metallic compounds generally serves as catalyst. However, metals, in particular metals of the platinum group, applied to a carbon support are also known.

The support elements according to the prior art are generally woven meshes of conductive material, for example a woven mesh of nickel wires, silver wires or silver-coated nickel wires.

Carbon is likewise used in various forms for support elements according to the prior art, for example woven fabrics or papers made of carbon fibres. To increase the conductivity, the carbon can be combined with metal components, for example by deposition of metal on the carbon or by means of mixed woven fabrics made of carbon fibres and metallic fibres and filaments.

In the prior art, the support elements have two important functions: they firstly serve as mechanical support for the catalyst-containing layer during and after manufacture of the electrodes and, secondly, ensure distribution of the current to the reaction sites.

A disadvantage of the support elements known in the prior art is that they are largely catalytically inactive and reduce the activity per unit volume of the oxygen-consuming electrode. In addition, the support elements reduce the free area available for mass transfer through the oxygen-consuming electrode. This hinders a mass transfer and thus reduces the performance of the oxygen-consuming electrode.

The present invention may therefore provide an oxygen-consuming electrode, in particular for use in chloralkali electrolysis, which overcomes the above disadvantages.

### DESCRIPTION OF PREFERRED EMBODIMENTS

As used herein, the singular terms “a” and “the” are synonymous and used interchangeably with “one or more” and “at least one,” unless the language and/or context cleary indicates otherwise. Accordingly, for example, reference to “a coating” herein or in the appended claims can refer to a single coating or more than one coating. Additionally, all numerical values, unless otherwise specifically noted, are understood to be modified by the word “about.”

The present invention may provide an oxygen-consuming electrode which avoids the disadvantages due to the known support elements and in particular avoids hindrance of mass transfer by the support element.

This may be achieved by an oxygen-consuming electrode based on support elements composed of a material which can be at least partly removed by dissolution, decomposition, melting and/or vaporization and bringing into operation of this oxygen-consuming electrode by dissolving out or decomposing the support element.

An embodiment of the invention provides an oxygen-consuming electrode comprising a support in the form of a sheet-like structure and a coating comprising a gas diffusion layer and a catalytically active component, wherein the support is based on a material which can be at least partly removed by dissolution, decomposition, melting and/or vaporization.

Thus, the support initially required for application of the catalytic component and production of the gas diffusion layer may be at least partly removed again from the finished electrode in order to utilize the resulting voids for easier mass transfer, e.g. of electrolyte to the catalytically active components.

Embodiments of the invention utilize the self-supporting properties of the gas diffusion layer as substitute for the mechanical properties of the support.

The oxygen-consuming electrodes produced as described herein are sufficiently mechanically stable and surprisingly display better performance than conventional oxygen electrodes.

Suitable materials for the support are in principle selected polymers, mineral fibres and metals. In an embodiment of the invention, the support material can be dissolved from the electrode or decomposed by means of water or aqueous solutions, in particular acidic or basic solutions. Examples of preferred water-soluble materials are polyvinyl alcohol and polyvinylpyrrolidone.

The removal of the support can be effected by dissolution, melting, vaporization or decomposition. Suitable media for the decomposition/dissolution are water, alkalis, acids, organic solvents. The decomposition can be aided by additional heating or irradiation, or by heating and/or irradiation.

For dissolution in an alkali medium, it is possible to employ, in each case, reagents in which the respective materials of the support dissolve.

One variation of the oxygen-consuming electrode is characterized in that the support material can be dissolved from the electrode or decomposed by means of basic aqueous solutions having a pH of at least 9, preferably by action of caustic alkalis from the group consisting of: sodium hydroxide, potassium hydroxide, preferably sodium hydroxide.

In particular, it is possible to use metals which are not stable to alkali, e.g. aluminium, tin, zinc, beryllium.

Preference is therefore also given to support materials which can be attacked by bases, in particular materials selected from the group consisting of: polyesters, in particular polyethylene terephthalate, polybutylene terephthalate and copolymers thereof, polyvinylidene fluoride; aluminium; mineral fibres, in particular fibres made of E glass, R glass, S glass, A glass, C glass, D glass.

For dissolution in an acidic medium, it is in each case possible to employ reagents in which the respective materials of the support dissolve. It is possible to use both inorganic and organic acids. Preference is given to acids in the case of which no contamination with anions which adversely affect the catalyst is to be feared. A preferred acid is therefore sulphuric acid.

The support material can preferably be dissolved from the electrode or decomposed by means of acidic aqueous solutions having a pH of not more than 5, particularly preferably by action of mineral acids, particularly preferably by means of sulphuric acid.

In particular, metals which are unstable to acid, e.g. aluminium, zinc or iron, can be used.

Particular preference is given to an embodiment of the oxygen-consuming electrode in which the support material is based on a material from the group consisting of: aluminium and zinc and alloys thereof and polyamides.

For dissolution by means of solvents, it is possible in each case to employ reagents in which the respective materials of the support dissolve. It is possible to use, for example, toluene or methylene chloride for dissolving out a polystyrene or polycarbonate matrix or ethylene carbonate for dissolving out a polyacrylonitrile matrix. Solvents suitable for the respective materials are known in principle to those skilled in the art.

Another variation of the oxygen-consuming electrode is characterized in that the support material is a material which can be dissolved from the electrode or decomposed by means of organic solvents.

Preference is therefore also given to support materials which can be attacked by means of organic solvents, in. particular support materials selected from the group consisting of: polyacrylonitrile, polycarbonate and polystyrene. Suitable polymers are, for example, water-soluble polymers such as polyvinyl alcohol or polyvinylpyrrolidone and also polyacrylonitrile, polyamide 6, polyamide 6.6, polyamide 11, polyamide 12, polycarbonate, polystyrene and copolymers such as ABS, SAN, ASA, polyphenylene oxide, polyurethane, polyesters, in particular polyethylene terephthalate, polybutylene terephthalate, polyvinyl acetate, ethylene-vinyl acetate, polyvinylidene chloride, polymethyl (meth)acrylate, polybutylenes, cellulose acetate, polylactides and copolymers and blends of the polymers mentioned.

Suitable mineral fibres are glass fibres, preferably fibres made of E glass, R glass, S glass, A glass, C glass, D glass.

However, as an alternative, cellulose-based natural materials such as cotton or sisal or else wool can also be used as support material.

It is likewise possible to use combinations of the abovementioned materials.

Metal alloys which have a low melting point, for example bismuth/tin or other alloys of bismuth with tin, lead, cadmium and/or further components, are likewise suitable.

It is also possible to use combinations of the abovementioned materials.

Preference is given to materials which decompose and/or dissolve in water and/or alkaline aqueous solutions. Particular preference is given to materials which decompose and/or dissolve in alkaline aqueous solutions.

The support can be used in the form of woven fabrics/meshes, knittes, nonwovens, perforated films, foams or other permeable sheet-like structures. It is also possible to use multilayer structures, for example two or more layers of woven fabrics/meshes, knittes, nonwovens, perforated films, foams or other permeable sheet-like structures. The layers can have different thicknesses and different mesh openings or perforations. The supports or the precursors thereof can be treated with sizes or other additives to improve processability.

The sheet-like structure of the support is, in some embodiments of the invention, present in the form of a woven fabric/mesh, knittes, nonwoven, perforated film, foam, preferably as woven fabric/mesh, and in particular is made up of a plurality of layers.

A preferred form of the oxygen-consuming electrode is characterized in that the gas diffusion layer is based on a fluorinated polymer, in particular on polytetrafluoroethylene, and optionally catalytically active material in addition.

In some embodiments, the catalytically active component is selected from the group consisting of: silver, silver(I) oxide, silver(II) oxide and mixtures thereof, in particular a mixture of silver and silver(I) oxide.

Coating of the support can be carried out using conventional techniques known per se.

Silver catalysts have been found to be particularly useful for the electrolysis of alkali metal chlorides using oxygen-consuming cathodes.

In the production of OCEs having a silver catalyst, the silver can preferably be introduced at least partly in the form of silver(I) or silver(II) oxides which are then reduced to metallic silver. The reduction is carried out either in the initial phase of the electrolysis in which conditions for reduction of silver compounds prevail or in a separate step by electrochemical, chemical or other means known to those skilled in the art before the electrode is brought into operation. In the reduction of the silver compounds, a change in the arrangement of the crystallites, in particular also bridge formation between individual silver particles, occurs. This leads overall to a strengthening of the structure.

In the production of oxygen-consuming electrodes, a distinction may be made in principle between dry and wet manufacturing processes.

In the dry processes, a mixture of catalyst and a polymeric component is milled to fine particles which are subsequently distributed on the support element and pressed at room temperature. Such a process is described, for example, in EP 1728896 A2.

Preferred catalysts for use in the invention are silver, silver(I) oxide, silver(II) oxide or mixtures thereof, and the preferred support is a mesh made of polymer or metal wires having a wire diameter of 0.1-0.3 mm and a mesh opening of 0.2-1.2 mm.

In the wet manufacturing processes, either a paste or a suspension of catalyst and polymeric component is used. Surface-active substances can be added in the production of the pastes or suspension in order to increase the stability of the latter. The pastes are applied to the support element by means of screen printing or calendering, while the less viscous suspensions are usually sprayed onto the support element. The paste or suspension is dried under mild conditions after rinsing out the emulsifier and is then sintered at temperatures in the region of the melting point of the polymer. Such a process is described, for example, in US 20060175195 A1.

Earlier publications also disclose processes in which the mixture of catalyst and polymer is densified in a first step to form a sheet-like structure (“rolled sheet”) and this structure is then pressed into the support element. Examples of such processes are described in DE10148599 A1 or EP0115845B1. Since these sheet-like structures have a low mechanical stability, these processes have been found to be of little use in industrial practice. Preference is therefore given to those processes in which coating of the support element with the mixture of catalyst and polymer is carried out first and densification and strengthening are carried out in further steps.

Thus, supports made of the abovementioned soluble or decomposable materials can be used in the drying process mentioned. As material for the support, mention may here be made by way of example, but without restricting the invention thereto, of a woven fabric made of PET monofilaments. The woven fabrics of PET monofilaments are sufficiently dimensionally stable and can be coated using the techniques described. The catalytically active composition is strengthened without introduction of heat, so that the structure and strength of the support element are retained in this manufacturing step. This gives an electrode from which the support is removed in a further step.

The removal can be carried out in a separate step by action of concentrated sodium hydroxide solution on the electrode after the strengthening step. After decomposition of the PET, the electrode is then rinsed with further alkali solution and optionally water to remove residues of terephthalate and ethylene glycols. This gives an oxygen-consuming electrode which can be installed in an element and can be used, for example, for the production of sodium hydroxide.

However, in one variation, the electrode can also be installed after densification of the catalytically active layer in an electrolysis element which is used for the electrolysis of alkali metal chloride solutions. In the initial phase, the cathode produces a contaminated alkali solution which is kept separate and passed to a use in which contamination by terephthalate and ethylene glycols does not interfere. After this initial phase, a high-performance OCE by means of which in-specification alkali metal hydroxide can be produced is obtained.

As an alternative, a woven fabric made of polycarbonate monofilaments can be used in the abovementioned dry process. The monofilaments are then dissolved out by means of methylene chloride or another solvent after densification of the catalytically active layer and rinsing with methylene chloride and evaporation of solvent residues then gives a functional oxygen-consuming electrode.

In the same way, supports made of the soluble or decomposable materials mentioned can be used in the wet process mentioned. Preference is given here to materials whose melting point is above the sintering temperature. As material for the support, mention may here be made by way of example, without restricting the invention thereto, of a woven mesh of aluminium wire. The woven meshes of aluminium wire can be coated by means of the techniques described in a manner analogous to conventional woven meshes of nickel or silver wire. The catalytically active layer is then densified and sintered using the known techniques. This gives an electrode from which the support is removed in a further step.

The removal of the aluminium wire mesh by means of alkali metal hydroxide solution is preferably carried out in a separate unit which has precautions for safe discharge of the hydrogen formed. After decomposition of the aluminium support, the electrode is then rinsed with further alkali and optionally water in order to remove residues of aluminium hydroxide. This gives an oxygen-consuming electrode which can be installed in an element and can, for example, be used for the production of sodium hydroxide.

As an alternative, a woven fabric/mesh of glass fibres can be used in the abovementioned wet process. After coating, densification and sintering, the electrode is, in one variation, installed in a cathode element used for the electrolysis of alkali metal chloride solutions. In the initial phase, this cathode produces .an alkali solution which is contaminated with silicate and other constituents and is kept separate and passed to a use in which the contamination does not interfere. After this initial phase, a high-performance OCE by means of which in-specification alkali metal hydroxide can be produced is obtained.

The oxygen-consuming electrode is preferably connected as cathode, in particular in an electrolysis cell for the electrolysis of alkali metal chlorides, preferably sodium chloride or potassium chloride, particularly preferably sodium chloride.

Embodiments of the invention further provide an electrolysis process, in particular for chloralkali electrolysis, using an oxygen-consuming electrode as described here as cathode and an anode in a membrane electrolyser, characterized in that the support material is at least partly removed before the oxygen-consuming electrode is taken into operation and the oxygen-consuming electrode is operated as cathode.

As an alternative, the oxygen-consuming electrode can preferably be connected as cathode in a fuel cell.

Embodiments of the invention also provide a process for generating power using an oxygen-consuming electrode as described herein as cathode in an alkaline fuel cell, characterized in that the support material is at least partly removed before the oxygen-consuming electrode is taken into operation and the oxygen-consuming electrode is operated as cathode.

Embodiments of the invention therefore further provide for the use of the oxygen-consuming electrode as described herein for the reduction of oxygen in an alkaline medium, in particular in an alkaline fuel cell or as electrode in a metal/air battery, use in mains water treatment, for example for producing sodium hypochlorite, or use in chloralkali electrolysis, in particular for the electrolysis of LiCl, KCl or NaCl.

The OCE is particularly preferably used in chloralkali electrolysis and here especially in the electrolysis of sodium chloride (NaCl).

Embodiments of the invention further provide an electrolysis apparatus, in particular for chloralkali electrolysis, having an oxygen-consuming electrode as described here as oxygen-consuming cathode.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

All the references described above are incorporated by reference in their entireties for all useful purposes.

### EXAMPLES

### Example

3.5 kg of a powder mixture consisting of 7% by weight of PTFE powder, 88% by weight of silver(I) oxide and 5% by weight of silver powder of the grade 331 from Ferro were mixed at a rotational speed of 6000 rpm in an Eirich model R02 mixer equipped with a star spinner as mixing element in such a way that the temperature of the powder mixture does not exceed 55° C. This was achieved by the mixing operation being interrupted and the mixture being cooled in a cooling chamber. Mixing was carried out a total of three times. After mixing, the powder mixture was sieved by means of a fine sieve having a mesh opening of 1.0 mm.

The sieved powder mixture was subsequently applied to a mesh made of aluminium wires having a wire thickness of 0.25 mm and a mesh opening of 0.5 mm. Application was carried out with the aid of a 2 mm thick template, with the powder being applied by means of a sieve having a mesh opening of 0.1 mm. Excess powder which projected above the thickness of the template was removed by means of a scraper. After removal of the template, the support together with the applied powder mixture was pressed by means of a roller press at a pressing force of 0.5 kN/cm.

The gas diffusion electrode obtained in this way was transferred to a bath containing 32% strength sodium hydroxide solution. Hydrogen gas was evolved and was discharged into a strong stream of air. The electrode was taken from the sodium hydroxide bath after 18 hours and rinsed with distilled water.

A potential of 0.764 V relative to the reversible hydrogen electrode (HydroFlex® from Gaskatel) was measured for the electrode by means of electrochemical impedance spectroscopy in a half cell at 4 kA/m² and 80° C. The potential was corrected for the potential losses of the measurement arrangement.

### Example 2

### Comparative Example

A gas electrode was produced by the procedure described in Example 1 using a mesh of silver-coated nickel wires and having otherwise the same dimensions instead of a mesh of aluminium wires and accordingly not carrying out a dissolution of the support structure.

A potential of 0.752 V relative to the reversible hydrogen electrode (HydroFlex® from Gaskatel) was measured for the electrode by means of electrochemical impedance spectroscopy in a half cell at 4 kA/m² and 80° C. The potential was corrected for the potential losses of the measurement arrangement.

Comparison of the electrode according to the invention with the conventional electrode shows a potential which is better by 12 mV.

1. An oxygen-consuming electrode comprising
a support in the form of a sheet-like structure and
a coating comprising
a gas diffusion layer and
a catalytically active component,
wherein the support is based on a material which can be at least partly removed by dissolution, decomposition, melting and/or vaporization.

2. The oxygen-consuming electrode according to claim 1, wherein the support material can be dissolved from the electrode or decomposed with water or an aqueous solution.

3. The oxygen-consuming electrode according to claim 2, wherein the aqueous solution comprises an acidic or a basic solution.

4. The oxygen-consuming electrode according to claim 1, wherein the support material can be dissolved from the electrode or decomposed with an acidic aqueous solution having a pH of not more than 5.

5. The oxygen-consuming electrode according to claim 4, wherein the acidic aqueous solution comprises a mineral acid.

6. The oxygen-consuming electrode according to claim 4, wherein the acidic aqueous solution comprises sulphuric acid.

7. The oxygen-consuming electrode according to claim 1, wherein the support is based on a material selected from the group consisting of: aluminium, zinc, alloys of aluminium, alloys of zinc, and polyamides.

8. The oxygen-consuming electrode according to claim 1, wherein the support material can be dissolved from the electrode or decomposed with a basic aqueous solution having a pH of at least 9.

9. The oxygen-consuming electrode according to claim 8, wherein the basic aqueous solution comprises an alkali metal hydroxide solution selected from the group consisting of: sodium hydroxide solution and potassium hydroxide solution.

10. The oxygen-consuming electrode according to claim 1, wherein the support material is selected from the group consisting of: polyesters, polybutylene terephthalate and copolymers thereof, polyvinylidene fluoride, aluminium, and mineral fibres.

11. The oxygen-consuming electrod according to claim 10, wherein the support material comprises polyethylene terephthalate.

12. The oxygen-consuming electrode according to claim 10, wherein the support material comprises fibres made of E glass, R glass, S glass, A glass, C glass, or D glass.

13. The oxygen-consuming electrode according to claim 1, wherein the support material can be dissolved from the electrode or decomposed with an organic solvent.

14. The oxygen-consuming electrode according to claim 1, wherein the support material is selected from the group consisting of: polyacrylonitrile, polycarbonate, and polystyrene.

15. The oxygen-consuming electrode according to claim 13, wherein the support material is selected from the group consisting of: polyacrylonitrile, polycarbonate, and polystyrene.

16. The oxygen-consuming electrode according to claim 1, wherein the support material comprises polyvinyl alcohol or polyvinylpyrrolidone.

17. The oxygen-consuming electrode according to claim 1, wherein the sheet-like structure of the support is present in the form of a woven fabric/mesh, knittes, nonwoven, perforated film, or foam.

18. The oxygen-consuming electrode according to claim 1, wherein the sheet-like structure of the support is present in the form of a woven fabric/mesh.

19. The oxygen-consuming electrode according to claim 1, wherein the support comprises a plurality of layers.

20. The oxygen-consuming electrode according to claim 1, wherein the gas diffusion layer comprises a fluorinated polymer.

21. The oxygen-consuming electrode according to claim 1, wherein the gas diffusion layer comprises polytetrafluoroethylene.

22. The oxygen-consuming electrode according to claim 20, wherein the gas diffusion layer further comprises a catalytically active material.

23. The oxygen-consuming electrode according to claim 1, wherein the catalytically active component is selected from the group consisting of: silver, silver(I) oxide, silver(II) oxide, and mixtures thereof.

24. The oxygen-consuming electrode according to claim 22, wherein the catalytically active material is selected from the group consisting of: silver, silver(I) oxide, silver(II) oxide, and mixtures thereof.

25. The oxygen-consuming electrode according to claim 1, wherein the catalytically active component comprises a mixture of silver and silver(I) oxide.

26. An electrolysis process, in particular for chloralkali electrolysis, comprising
providing a membrane electrolyser comprising the oxygen-consuming electrode according to claim as cathode and an anode
at least partly removing the support material before the oxygen-consuming electrode is taken into operation, and
operating the electrolyser with the oxygen consuming electrode as cathode.

27. A process for generating power comprising
providing an alkaline fuel cell which comprises the oxygen-consuming electrode according to claim 1 as an anode and a cathode,
at least partly removing the support material before the oxygen-consuming electrode is taken into operation, and
operating the alkaline fuel cell with the oxygen-consuming electrode as cathode.

28. An alkaline fuel cell or a metal/air battery comprising the oxygen-consuming electrode according to claim 1.

29. An electrolysis apparatus comprising the oxygen-consuming electrode according to claim 1 as an oxygen-consuming cathode.
